(19) United States
(12) Patent Application Publication
(10) Pub. No.: US 2009/0013902 A1
(43) Pub. Date: Jan. 15, 2009

(54) Shark repellant surfboard wax and method of making same

(76) Inventor: Patrick E. Semasko, Lahaina, HI (US)

Correspondence Address: JAMES E. BRUNTON, ESQ., P. O. BOX 29000, GLENDALE, CA, 91209, US

(21) Appl. No.: 11/827,508

(22) Filed: Jul. 11, 2007

(51) Int. Cl. C09D 191/06

(52) U.S. Cl. 106/270

(57) ABSTRACT

An improved delivery system and the method of making same for delivering a shark repelling substance to the surface of an article such as a surfboard, boogie board and the like. The delivery system is provided in the form of a board wax applicator that contains a chemical shark repelling substance such as a mixture of anhydrous sodium sulfate and sodium laurel sulfate.

### BACKGROUND OF THE INVENTION

1. Field of the Invention

The present invention relates generally to the field of water sports. More particularly the invention concerns a shark repellent surfboard wax and the method of making same that contains an effective shark repelling substance.

2. Discussion of the Prior Art

Shark attacks, although few, are serious and can be fatal. Chemical shark repellents are sometimes used in diving and the fishing industries, but nothing is currently available for use by the recreational participant in aquatic activities such as surfboarding and the like.

Chemical techniques are dependant on both the particular formulation of the shark repelling substance and the method or device for delivering the substance into the aquatic environment. A common shark repelling substance comprises anhydrous sodium sulfate that is mixed in equal parts by volume with sodium laurel sulfate. Other chemical repellents are being developed, but to be effective, the substance must be present prior to a shark's curiosity to bite. More recently a repellent compound has been produced from dead sharks. This substance has outperformed any known chemical shark repellant and can be integrated into a wax compound.

Wax compounds used on aquatic devices can be created with multiple compounds and still provide the same benefits as ordinary wax. U.S. Pat. No. 6,764,750 issued to Claycomb discloses a multi-layer surfboard wax system for waxing a surf board. The Claycomb system includes both a higher melting point basecoat wax and a second topcoat wax in the same bar. The two waxes are bonded together so that the surfer can carry a single bar of wax into the water and use it to apply both the base coat and the topcoat of wax. However, the Claycomb system provides no protection against predatory animals such as sharks.

One form of a prior art shark repellant delivery system is described in U.S. Pat. No. 4,917,280 issued to Schneider. The Schneider patent discloses a belt including a pair of opposite layers of sheet material and subdivided into a series of pockets for receiving pellets of shark-repulsive chemical. One of the pellets is untreated so as to dissolve in water relatively quickly, another of the pellets is impregnated with water soluble glue, and another of the pellets is coated with the glue while a fourth of the pellets are coated with epoxy for preventing water application to the chemical of the pellet until the pellet is manually broken. The configuration of the belt allows water to enter the cells the instant the belt is immersed in the water. Although such an arrangement provides a steady dispersal of chemical repellant into the water, a wearer is unable to delay the moment of dispersal, making it unsuitable for a diver or surfer who might not encounter a shark immediately upon entry to the water.

Yet another shark repellent delivery system is disclosed in U.S. Pat. No. 4,816,260 issued to Wollrich. The Wollrich patent concerns a personal protection device that includes a flexible support and a breakable capsule at a front surface of the support, which capsule contains skunk essence. In using the Wollrich device bending the support ruptures the capsule and disperses the repellant into the environment. Although such an arrangement allows for the repellant to be dispersed on demand, the necessary rigidity of the support does not lend itself to applications wherein it would be preferable to have a compliant support, such as a wrist or ankle band. Additionally, the technique required to burst the capsule is incompatible with applications wherein it would be preferable to affix the device to a wetsuit or other article of scuba gear to provide ready access to the device.

In view of these limitations of the prior art with respect to the needs of aquatic activities where a wax is used, the thrust of the present invention is to provide in an article of common use an easy-to-use delivery system for a chemical shark repellant. More particularly the present invention is directed toward providing a shark repellent delivery system that comprises an easy-to-use board wax that can be compactly packaged and produced relatively inexpensively.

### SUMMARY OF THE INVENTION

It is an object of the present invention to provide a novel surfboard wax and the method of making same that contains a shark repelling substance. More particularly, it is an object of the invention to provide an improved delivery system for delivering a shark repelling substance to the surface of an article such as a surfboard, boogie board and the like.

Another object of the invention is to provide a surfboard wax of the aforementioned character that is easy-to-use, can be easily applied to the board, and includes a highly effective shark repellant.

Another object of the invention is to provide a shark repellant board wax that delivers a chemical shark repellant into an aqueous environment upon contact with water.

Another object of the invention is to provide a shark repellant board wax that includes a wax compound commonly used in board wax as well as a chemical repellent that is blended together with the wax compound to form a shark repellent wax-like material that can be readily applied to an aquatic device such as a surfboard.

Another object of the invention is to provide a method of making a shark repellent board wax that includes the steps of: melting various compounds to create a board wax; allowing the board wax to thicken; blending a suitable shark repellant into the thickened wax compound to form a shark repellent compound; placing a pre-determined amount of the shark repellent compound into a mold of a suitable size and configuration to form a molded shark repellent compound; and controllably cooling the molded shark repellent wax compound.

### BRIEF DESCRIPTION OF THE DRAWINGS

FIG. 1 is a generally perspective view of one form of the shark repellent board wax article of the invention.

FIG. 2 is a generally perspective view of an alternate form of the shark repellent board wax article of the invention

### DESCRIPTION OF THE INVENTION

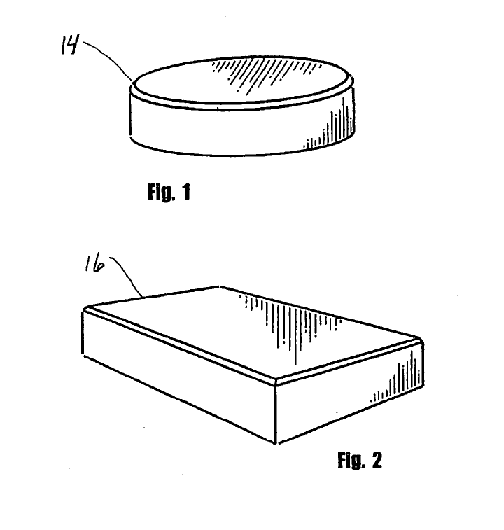

Referring to the drawings and particularly FIG. 1, one form of the shark repellent board wax applicator of the present invention is there shown in generally designated by the numeral 14. Applicator 14, which is here shown as being generally cylindrical in shape, comprises a novel wax system in which wax compounds and a suitable chemical shark repellent are combined in accordance with the method of the invention the details of which will presently be described.

The wax compound, which is inter-mixed with the chemical shark repellent, may be synthetic or natural compounds that are readily obtainable from a number of commercial suppliers. In this regard a suitable synthetic wax can be produced from a mixture of about 60% paraffin, about 20% microcrystalline, about 10% petroleum jelly and about 10% Vistenex; similarly, a natural wax compound can be produced from a mixture of about 2200 grams of beeswax and about 750 milliliters of coconut oil. While the melting points of the wax compounds may very, paraffin has a melting point of between about 47° Celsius and about 64° Celsius and beeswax has a melting point of between about 62° Celsius and about 64° Celsius.

Dyes, scents and various particulates can be incorporated into the wax compound as desired to provide distinguishing characteristics for water conditions and packaging.

A number of readily commercially available shark repelling substances can be inter-mixed with the natural or synthetic wax compound to produce the shark repellent board wax of the invention. In the preferred form of the invention the shark repelling substance comprises anhydrous sodium sulfate that is mixed in equal parts by volume with sodium laurel sulfate. Wax compounds having varying melting temperatures can be used to accommodate for varying ocean temperatures. Additionally the ratio of wax compound to chemical shark repelling substance can be adjusted to suit the need of various environmental variables and user preferences.

Dyes, scents and particulates may also be incorporated into the wax compound to provide various distinguishing characteristics for water conditions and or packaging.

Once the chemical repellent is inter-mixed with the wax compound in accordance with the method of the invention to form the board wax applicator of the invention, the applicator can be packaged in various shapes and sizes to accommodate a variety of boards, water conditions and user preferences.

The shark repellent board wax applicator of the present invention can be used with virtually any type of board used for water sports, including surfboards, wakeboards, boogie boards and so forth, and is not limited to any particular use.

The shark repellent board wax applicator of the present invention can be produced in various sizes to accommodate a variety of boards, water conditions and user preferences. Varying sets of melting temperature waxes and compounds can be used for different ocean temperatures and combined for the end product. Additionally the wax to repellent ratio can be adjusted to suit the need of various environmental variables and or user preference.

Referring to FIG. 2 of the drawings, an alternate form of the shark repellent board wax applicator of the present invention is there shown and generally identified by the numeral 16. Applicator 16 contains the identical compounds previously discussed and is manufactured in basically the same manner as applicator 14. However, applicator 16, rather than being generally cylindrical in shape is generally cubic in shape.

The examples set forth in the paragraphs which follow exemplify the methods of the invention for making the shark repellent board wax applicator of the invention.

### EXAMPLE 1

A wax compound comprising a mixture of paraffin, microcrystalline, petroleum jelly and Vistenex is placed in a suitable crucible and is elevated to a temperature of between about 40 degrees Celsius and about 70 degrees Celsius to melt the wax compound to form a molten wax compound. Next the molten wax compound is inter-mixed, using an appropriate stirring implement, with a mixture of anhydrous sodium sulfate and sodium laurel sulfate to form a molten shark repellent wax compound. The mixture of the molten wax with the anhydrous sodium sulfate and sodium laurel sulfate mixture is preferably in a ratio of approximately 20 parts of molten wax compound to one part of the mixture of anhydrous sodium sulfate and sodium laurel sulfate to form a molten shark repellent wax compound. The molten shark repellent wax compound is then poured from the melting crucible into a generally cylindrically shaped mold and allow to cool to form the application article of the invention illustrated in FIG. 1 of the drawings for applying the shark repellent wax compound to a board, such as a surfboard.

### EXAMPLE 2

A wax compound comprising a mixture of beeswax and coconut oil is placed in a suitable crucible and is elevated to a temperature of between about 60° Celsius and about 70° Celsius to melt the wax compound to form a molten wax compound. Next the molten wax compound is inter-mixed with a mixture of anhydrous sodium sulfate and sodium laurel sulfate to form a molten shark repellent wax compound in a ratio of approximately 20 parts of molten wax compound to one part of the mixture of anhydrous sodium sulfate and sodium laurel sulfate to form a molten shark repellent wax compound. The molten shark repellent wax compound is then poured from the melting crucible into a generally cubic-shaped mold and allowed to cool to form the application article of the invention illustrated in FIG. 2 of the drawings for applying the shark repellent wax compound to a board, such as a surfboard.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A shark repellent board wax applicator comprising a wax compound and a chemical shark repellent inter-mixed with said wax compound.

2. The shark repellent board wax applicator as defined in claim 1 in which said applicator is generally cylindrical in shape.

3. The shark repellent board wax applicator as defined in claim 1 in which said applicator is generally cubic in shape.

4. A method of making a shark repellent board wax applicator comprising the steps of:
(a) raising the temperature of a wax compound to a temperature sufficient to melt the wax compound to form a melted wax compound; and
(b) inter-mixing with said melted wax compound a chemical shark repellent to form a shark repellent wax compound.

5. The method as defined in claim 4 in which said chemical shark repellent comprises a mixture of anhydrous sodium sulfate and sodium laurel sulfate.

6. The method as defined in claim 4 in which said wax compound comprises a mixture of paraffin, microcrystalline, petroleum jelly and Vistenex.

7. The method as defined in claim 4 in which said wax compound comprises a mixture of beeswax and coconut oil.

8. A method of making a shark repellent board wax applicator comprising the steps of:
(a) raising the temperature of a wax compound comprising a mixture of paraffin, microcrystalline, petroleum jelly and Vistenex to a temperature sufficient to melt the wax compound to form a molten wax compound;
(b) inter-mixing with said molten melted wax compound a chemical shark repellent comprising a mixture of anhydrous sodium sulfate and sodium laurel sulfate to form a molten shark repellent wax compound; and
(c) molding and cooling said molten shark repellent wax compound to form an application article.

9. The method as defined in claim 8 in which said molten wax compound is heated to a temperature of between about 40 degrees Celsius and about 70 degrees Celsius.

10. A method of making a shark repellent board wax applicator comprising the steps of:
(a) raising the temperature of a wax compound comprising a mixture of paraffin, microcrystalline, petroleum jelly and Vistenex to a temperature of between about 40 degrees Celsius and about 70 degrees Celsius to melt the wax compound to form a molten wax compound;
(b) inter-mixing with 20 parts of said molten wax compound one part of a chemical shark repellent comprising a mixture of anhydrous sodium sulfate and sodium laurel sulfate to form a molten shark repellent wax compound;
(c) pouring said molten shark repellent wax compound into a mold; and
(d) cooling said molten shark repellent wax compound to form an application article for applying said shark repellent wax compound to a surfboard.
